(19) United States
(12) Patent Application Publication
(10) Pub. No.: US 2026/0054294 A1
(43) Pub. Date: Feb. 26, 2026

(54) SPRAY WAND

(71) Applicant: W.M. Barr & Company, Inc., Memphis, TN (US)

(72) Inventors: Rachel A. Farmer, Memphis, TN (US); Dalton Bolgeo, Memphis, TN (US)

(21) Appl. No.: 19/305,329

(22) Filed: Aug. 20, 2025

Related U.S. Application Data
(60) Provisional application No. 63/685,351, filed on Aug. 21, 2024.

(51) Int. Cl. B08B 3/02

(52) U.S. Cl. CPC B08B 3/026; B08B 2203/0217

(57) ABSTRACT

A spray wand is disclosed. The spray wand comprises a spray body provided with a nozzle, a cartridge assembly having a replaceable cartridge disposed in the spray body, and a flow control valve for controlling a fluid flow through the spray wand. A movable member of the nozzle has an inwardly tapered orifice from which the fluid flow exits the spray wand in certain modes of operation. A cartridge of the cartridge assembly has an array of apertures to allow particles of solid chemistry of a desired size to flow from the cartridge assembly. The flow control valve comprises a piston, a sealing element disposed on the piston, and a biasing element to apply a biasing force on the piston. In some embodiments, the sealing element is over-molded on the piston to militate against deformation and leakage.

### CROSS-REFERENCE TO RELATED APPLICATION

This application claims the benefit of U.S. Provisional Patent Application Ser. No. 63/685,351, filed Aug. 21, 2024, the entirety of which is herein incorporated by reference.

### FIELD

The present disclosure relates to a spray wand, more particularly to a spray wand for use with a chemical or chemical formulation in solid form.

### BACKGROUND

Outdoor cleaning requires applying a significant amount of cleaner over large surface areas, such as house siding, roofs, decks, patios, and automobiles. The industry standard solution for addressing such cleaning activities is liquid based hose-end type products. These products typically contain a bottom reservoir where a concentrated liquid chemistry solution is stored. The final cleaning solution is created when a hose is attached to the nozzle of the device and water passes through the hose. Liquid concentrate is drawn up a dip tube and mixed with the water passing through the nozzle of the device. The diluted chemistry is then dispensed onto the surface to be cleaned.

Some problems with standard hose-end devices are that they tend to be very heavy, bulky, and ergonomically displeasing to use. Due to the location where the hose hooks into the device, the range of motion when cleaning is greatly hindered, and the added weight from the liquid concentrate creates the need for users to often use two hands when operating the device. Also, water flow restrictors tend to be used to ensure the correct dilution ratio is met. The use of these water flow restrictors can greatly diminish the overall reach of the diluted spray.

Thus, there is a need for a hose-end type product that is lighter and designed for an optimal ergonomic outdoor cleaning experience.

Accordingly, it would be desirable to develop a spray wand that provides an improved ergonomic outdoor cleaning experience, while optimizing a performance, effectiveness, and efficiency of the spray wand.

### SUMMARY

In concordance and agreement with the present disclosure, a spray wand with optimal performance, effectiveness, and efficiency that also provides an improved ergonomic outdoor cleaning experience, has surprisingly been discovered.

The spray wand of present disclosure solves the above referenced problems, including providing a device which is ergonomically superior to current hose-end products on the market and which can easily be held with one hand when in operation. The spray wand of the present disclosure can dilute concentrated solid chemistry consistently to deliver an output cleaning solution that contains a pesticidal active to kill microorganisms and be registered with the Environmental Protection Agency (EPA).

The spray wand of the present disclosure can be used to achieve the proper dilution of the solid chemistry to yield the optimal cleaning solution. Ensuring consistent and accurate dilution of solid chemistry to water is not only important for product longevity to clean large outdoor surface areas, but is even more important when ensuring the correct dosage of a pesticidal active (i.e. Calcium Hypochlorite) when killing microorganisms such as mold. Products delivering pesticidal actives must be qualified through Good Laboratory Practice (GLP) testing and registered with the EPA. Such GLP testing requires a specific range of pesticidal active concentration to be defined and tested against the killing of the intended microorganism to ensure efficacy of the final cleaning solution. A device delivering the final cleaning solution needs to consistently deliver the proper dilution ratio of pesticidal actives to ensure it is the same chemistry tested in GLP testing to be compliant with the EPA.

The spray wand of the present disclosure also allows water to pass over the solid chemistry and through a spray selector thereof in such a way that an output stream has further spray reach than current hose-end products on the market.

The spray wand of the present disclosure allows connection of a hose in such a way that the hose does not hinder range of motion when cleaning, and the device is light enough in weight so that the device can easily be held with only one hand when in operation. In order to achieve lighter weight, the device operates using chemistries of solid composition. This enables less weight to be used in the device since chemistries of solid composition are more concentrated than their liquid counterparts.

In one embodiment, a spray wand, comprises: a spray body provided with a nozzle; a valve assembly coupled to the spray body; and a cartridge assembly disposed in the spray body, the cartridge assembly comprising a cartridge including: a tubular member having a proximal end and a distal end; and a plurality of apertures formed in the distal end of the tubular member, wherein the apertures are arranged in opposing radial arrays.

As aspects of some embodiments, at least one of the apertures has a diameter in a range of about 0.050 inches to about 0.150 inches.

As aspects of some embodiments, the cartridge includes eight apertures.

In another embodiment, a spray wand, comprises: a spray body provided with a nozzle; a cartridge assembly disposed in the spray body; and a valve assembly coupled to the spray body, the valve assembly comprising: a housing having a chamfered end and provided with a hose nut; a first sealing element disposed within the hose nut, wherein the first sealing element is configured to sealingly engage the chamfered end of the housing; a flow control valve disposed in the housing; and a piston disposed in the housing, the piston provided with a second sealing element, wherein the piston is selectively positionable between a first position to militate against a flow of a fluid through the valve assembly and a second position to permit the flow of the fluid through the valve assembly.

As aspects of some embodiments, the first sealing element comprises a main body having an annular hub portion.

As aspects of some embodiments, the annular hub portion includes a generally planar contact region configured to interface with the chamfered end of the housing to form a generally fluid-tight seal therebetween.

As aspects of some embodiments, the piston includes one or more projections, forming fluid channels formed in an end thereof.

As aspects of some embodiments, the piston includes an annular flange having a seating surface for the sealing element.

As aspects of some embodiments, the piston includes an annular hub having a seating surface for the second sealing element.

As aspects of some embodiments, the second sealing element is an O-ring.

As aspects of some embodiments, the second sealing element is an over-molded sealing element.

As aspects of some embodiments, the second sealing element is produced from at least one of an ethylene propylene diene monomer (EPDM) material, a nitrile butadiene rubber material, and/or a fluoroelastomer material.

As aspects of some embodiments, the second sealing element has a compression set of about 25%.

As aspects of some embodiments, the spray wand further comprises a biasing element to apply a biasing force on the piston, wherein the biasing force is in a range of about 2.5 lbs./inch to about 6.5 lbs./inch.

As aspects of some embodiments, the biasing element urges the piston into the first position.

In yet another embodiment, a spray wand, comprises: a spray body provided with a nozzle, the nozzle comprising; a movable member; and an orifice formed in the movable member, the orifice having an inlet opening and an outlet opening, wherein the orifice includes an inner surface that slopes inward towards a centerline of the orifice; a valve assembly coupled to the spray body; and a cartridge assembly disposed in the spray body.

As aspects of some embodiments, an inner diameter of the orifice gradually decreases from the inlet opening of the orifice to the outlet opening thereof.

As aspects of some embodiments, an inner diameter of the orifice at the inlet opening is about 0.170 inches and an inner diameter of the orifice at the outlet opening is about 0.110 inches.

As aspects of some embodiments, a slope angle of the inner surface of the orifice relative to the centerline is in a range of about 0 degrees to about 45 degrees.

As aspects of some embodiments, a slope angle of the inner surface of the orifice relative to the centerline is about 6.5 degrees.

### BRIEF DESCRIPTION OF THE DRAWINGS

The above-mentioned, and other features and objects of the disclosures, and the manner of attaining them will become more apparent and the disclosure itself will be better understood by reference to the following description of embodiments of the disclosure taken in conjunction with the accompanying drawings, wherein:

FIG. 1 is a perspective view of a spray wand according to an embodiment of the present disclosure;

FIG. 2 is a side elevational view of the spray wand of FIG. 1;

FIG. 3 is a cross-sectional view of the spray wand of FIGS. 1 and 2;

FIG. 4 is an enlarged fragmentary cross-sectional view of the spray wand of FIGS. 1-3;

FIG. 5 is a front view of a nozzle of the spray wand shown in FIGS. 1-4 according to an embodiment of the present disclosure;

FIG. 6 is a perspective view of the cartridge assembly of the spray wand of FIGS. 1-4 according to an embodiment of the present disclosure;

FIG. 7 is an enlarged fragmentary perspective view of a closed end of the cartridge assembly shown in FIG. 6;

FIG. 8 is a perspective view of a flow member of the spray wand shown in FIGS. 1-4 according to an embodiment of the present disclosure;

FIG. 9 is an enlarged fragmentary sectional view of a portion of the spray wand shown in FIGS. 1-3 including the valve assembly of FIG. 9, wherein the valve assembly is in a closed “OFF” condition;

FIG. 10 is an enlarged fragmentary sectional view of a portion of the spray wand shown in FIGS. 1-3 including a valve assembly according to an embodiment of the present disclosure, wherein the valve assembly is in an open “ON” condition;

FIG. 11 is an enlarged rear view of a sealing element for a hose nut of the valve assembly of FIGS. 9 and 10 according to an embodiment of the present disclosure;

FIG. 12 is an enlarged rear perspective view of the sealing element of FIG. 11;

FIG. 13 is a top plan view of the sealing element of FIGS. 11 and 12;

FIG. 14 is a sectional view of the sealing element of FIGS. 11-13;

FIG. 15 is an enlarged fragmentary perspective sectional view of a portion of a valve assembly according to another embodiment of the present disclosure;

FIG. 16 is an enlarged fragmentary cross-sectional view of the valve assembly of FIG. 15, wherein the valve assembly is in an open “ON” condition;

FIG. 17 is a perspective view of a piston of the valve assembly of FIGS. 15 and 16;

FIG. 18 is an exploded view of a spray wand according to an embodiment of the present disclosure, wherein the spray wand includes a valve assembly including a piston with an over-molded sealing element;

FIG. 19 is an enlarged fragmentary perspective sectional view of a portion of the spray wand of FIG. 18, wherein the valve assembly is in an open “ON” condition;

FIG. 20 is a front perspective view of the piston with the over-molded sealing element of FIGS. 18 and 19;

FIG. 21 is an exploded front perspective view of the piston with the over-molded sealing element of FIGS. 18-20;

FIG. 22 is an exploded rear perspective view of the piston and the over-molded sealing element of FIGS. 18-21;

FIG. 23 is a front elevational view of the piston and the over-molded sealing element of FIGS. 18-22;

FIG. 24 is a rear elevational view of the piston and the over-molded sealing element of FIGS. 18-23;

FIG. 25 is a front perspective view of a piston with an over-molded sealing element for a flow control valve according to another embodiment of the present disclosure; and

FIG. 26 is a side elevational view of the piston of FIG. 25.

### DETAILED DESCRIPTION

The following description of technology is merely exemplary in nature of the subject matter, manufacture and use of one or more disclosures, and is not intended to limit the scope, application, or uses of any specific disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3- 10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

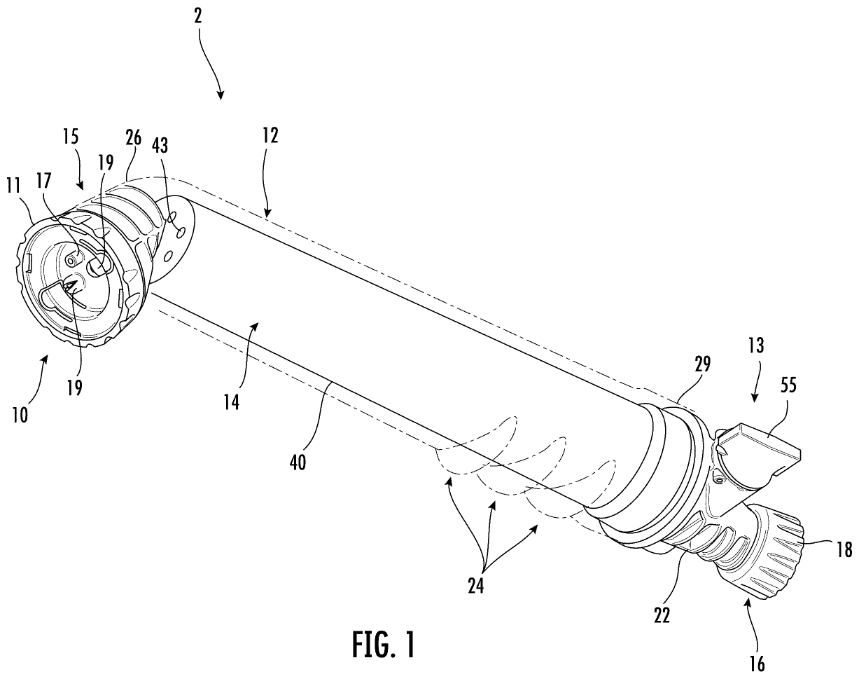

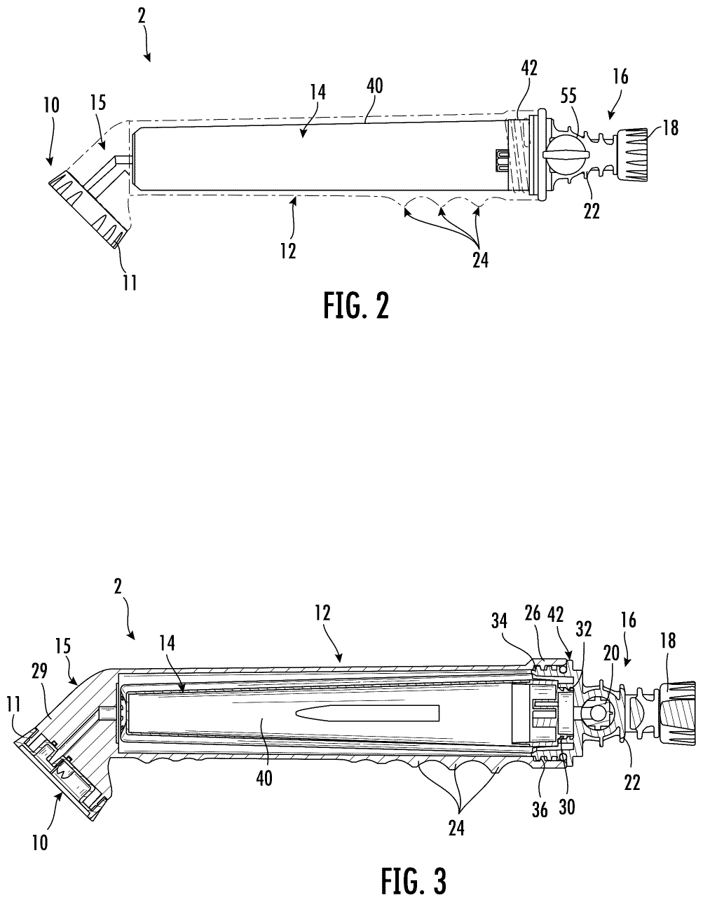

FIGS. 1-3 illustrate a spray wand 2 in accordance with an embodiment of the present disclosure. Details of exemplary structure and various functions of the spray wand 2 are disclosed in U.S. Pat. App. Pub. Nos. 2023/0166278 and 2025/0222493 and U.S. Pat. Nos. 11,679,404; 11,833,553; 12,103,025; and 12,263,508, which are incorporated herein by reference. The spray wand 2 has versatility in range of motion and is lighter in weight. Since the spray wand 2 can be maneuvered with one hand and a hose can be directly connected thereto, the spray wand 2 can easily be used in a variety of spraying applications. For example, the spray wand 2 can be used to clean various areas including around, above, underneath objects or other hard to reach places. The spray wand 2 can be used one-handed making it easier for a user to lift his/her arm to get an even further reach, unlike products requiring two hands to use.

Additionally, the spray wand 2 of the present disclosure generates higher fluid pressures and thus further reach of spray from out of the spray wand 2, making it well-suited for outdoor hard surfaces.

In some embodiments, the spray wand 2 comprises a non-disposable, hollow spray body 12 provided with a nozzle 10, a replaceable cartridge assembly 14 removably disposed inside of the spray body 12, and a valve assembly 13 releasably coupled to the spray body 12 opposite the nozzle 10. A flow of a fluid (e.g., water) (also referred herein as “source fluid”) from a fluid source and/or conduit (e.g., a hose) through the spray wand 2 may be selectively controlled with the valve assembly 13. The spray wand 2 depicted in FIGS. 1-3 includes an angled spray wand end 15 including the nozzle 10 and an opposite shut-off or source end 16. In some embodiments, one or more grip features 24 may be located on the spray body 12 of the spray wand 2. By locating the grip features 24 on the spray body 12 versus more proximate to the source end 16 of the spray wand 2 and/or on the valve assembly 13, torque on an arm of the user is minimized, thereby reducing user fatigue.

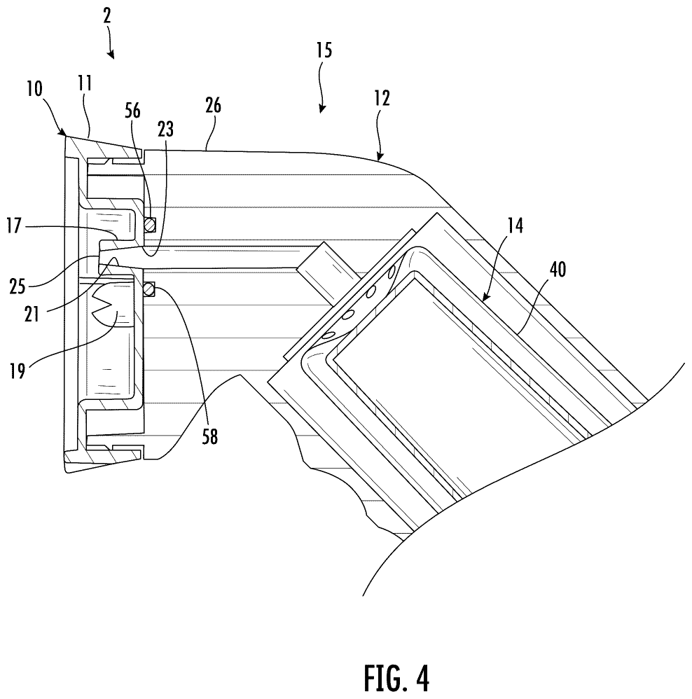

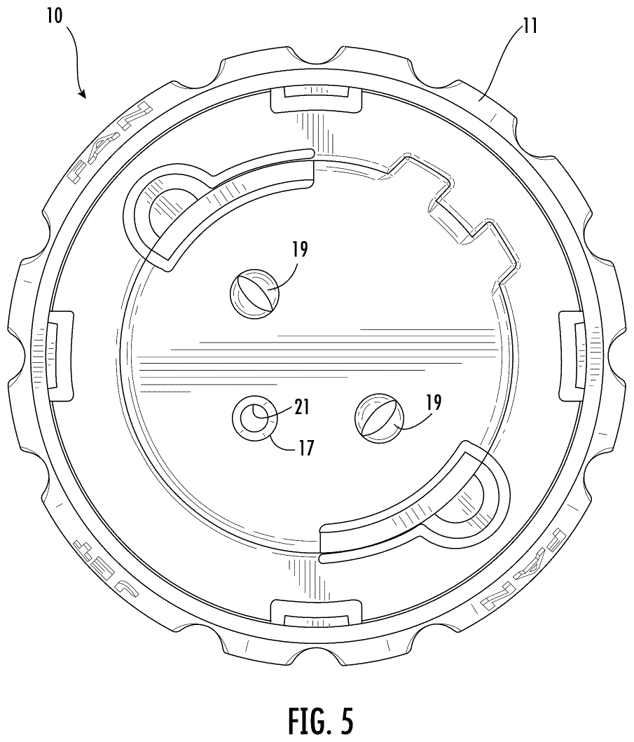

As illustrated, the nozzle 10 comprises a selectively positionable, movable member 11. The member 11 includes a stream orifice 17 and one or more spray orifices 19. As depicted in FIG. 5, the nozzle 10 has at least three selectable settings, “JET”, horizontal “FAN”, or vertical “FAN.” The “JET” setting utilizes the stream orifice 17 and each of the “FAN” settings utilizes one of the spray offices 19. As best seen in FIG. 4, the stream orifice 17 has an inwardly sloped inner surface 21 toward a centerline thereof, extending from an inlet opening 23 of the stream orifice 17 adjacent the spray body 12 to an outlet opening 25 thereof. This gradual reduction in an inner diameter of the stream orifice 17 from the inlet opening 23 to the outlet opening 25 increases a velocity of the flow of the fluid therethrough, thereby resulting in a greater spray distance. Preferably, the inner surface 21 is inwardly sloped at a slope angle in a range of about 0 degrees to about 45 degrees relative to the centerline of the stream orifice 17, and more preferably have a sloe angle of about 6.5 degrees relative to the centerline of the stream orifice 17. Accordingly, the inner diameter of the stream orifice 17 decreases from about 0.170 inches at the inlet opening 23 to about 0.110 inches at the outlet opening 25. It is understood that the slope angle of the inner surface 21 and the inner diameter of the stream orifice 17 is critical to the spray wand 2 in achieving the desired spray distance without experiencing a misting effect.

In some embodiment, the nozzle 10 is rotatable to allow selection of one of the settings. Particularly, the member 11 may be rotatable in a clockwise first direction and an opposite counterclockwise second direction. The member 11 may include one or more detents (not depicted) to cue the user by providing haptic feedback and maintain a position of the nozzle 10. The detents of the nozzle 10 interface and cooperate with one or more detent pockets (not depicted) in the spray body 12 to hold the nozzle 10 in a desired rotational position when in use. As more clearly shown in FIG. 4, a sealing element 56 may be disposed in a recess 58 of the spray body 12 to militate against leakage between the nozzle 10 and the spray body 12. It is understood that any suitable type of sealing element 56 may be employed such as an O-ring, for example.

As illustrated, the spray body 12 may be generally tubular and configured for receiving the cartridge assembly 14 therein. In some embodiments, the spray body 12 is comprised of a hollow tube, preferably transparent, with an angled wand spray end 26 attached to the nozzle 10 and an opposite open end 29. As shown in FIGS. 1-3, the cartridge assembly 14 may include a cartridge 40 and a flow member 42. The cartridge 40 holds a chemical or chemical formulation in solid form, also referred to herein as a solid chemistry. The solid chemistry may be preferably for cleaning, mold removal, or mildew removal purposes, among others. Examples of solid chemistry forms include, but are not limited to, pellets, tablets, or some other form of solid chemistry. Among other benefits, the solid chemistry lasts for an extended period of time relative to other known chemistries, reduces a mass of the spray wand 2 during use, eliminates liquid weight which contributes to added costs for shipping, and improves visual monitoring of chemistry consumption. The spray wand 2 of the present disclosure preferably contains a chemical or chemical formulation in a solid form such as a solid chlorine bleach. Non-limiting examples of chemical or chemical formulations include, but are not limited to, washing soda, baking soda, solid surfactants, calcium hypochlorite, sodium hypochlorite, citric acid, sodium sulfate, urea, quaternary amines, herbicides, insecticides, pesticides, fertilizers, and a combination thereof. Preferably, the chemical and/or chemical formulation includes calcium hypochlorite. Calcium hypochlorite contains over 70% active available chlorine and has a long shelf like when stored appropriately.

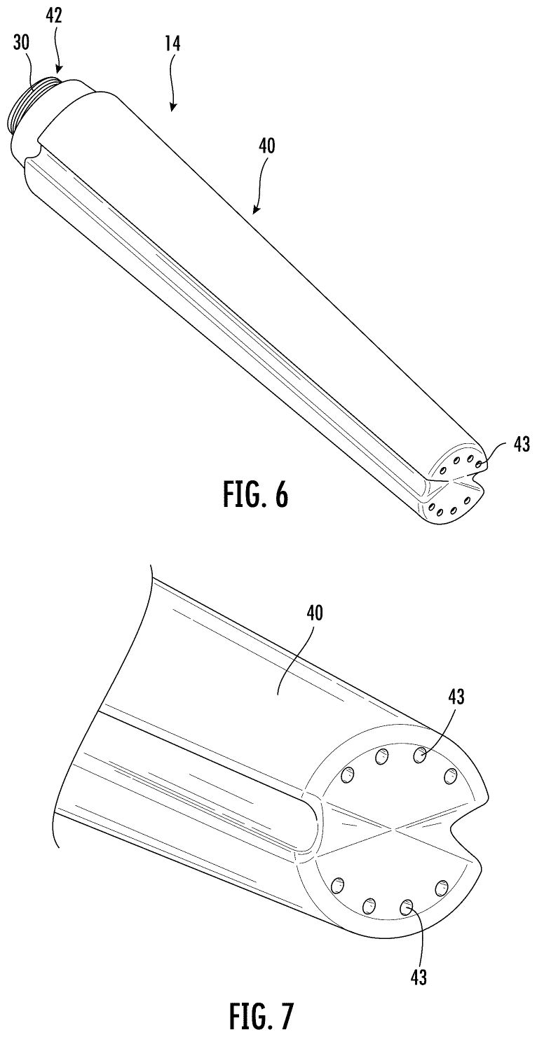

In some embodiments, the cartridge 40 may comprise a generally tubular member having an open proximal end and a generally closed distal end. One or more apertures 43 may be formed in the distal end of the tubular member. As illustrated more clearly in FIGS. 6 and 7, the apertures 43 may be arranged in opposing radial arrays. It is understood, however, that the apertures 43 may formed in the cartridge 40 in other various arrangements such as a full circular array, for example. The apertures 43 shown are generally circular-shaped having a diameter in a range of about 0.050 inches to about 0.150 inches, and more preferably, about 0.100 inches. It is understood, however, that a shape, size, and configuration of the apertures 43 may be any such shape, size, and configuration specifically designed to control an amount of the solid chemistry permitted mix with the flow of the fluid and/or a particle size of the solid chemistry permitted to exit the cartridge 40. By controlling the amount and/or the size of the solid chemistry the cartridge 40 is able to militate against blockage of the flow of the fluid through the spray wand 2, and more particularly the nozzle 10.

In some embodiments, the flow member 42 may be releasably coupled to or otherwise attached or affixed to the cartridge 40. For example, the flow member 42 may be releasably coupled to the cartridge 40 when the cartridge assembly 14 is designed to be refillable. In another example, when the cartridge assembly 14 is designed to be disposable and/or replaceable, the flow member 42 may be fixedly attached to the cartridge 40. In some embodiments, the flow member 42 may be inserted into the proximal end of the cartridge 40 until the flow member 42 contacts and/or abuts a shoulder of the cartridge 40. Coupling elements (e.g., prongs or tabs) extending as part of the flow member 42 may provide a snap feature to engage with the cartridge 40 preventing inadvertent removal yet allowing uncoupling when needed. It is also conceived that the flow member 42 may be attached to the cartridge 40 using various other methods such as a threaded connection, chemical adhesion, or welding, for example. The flow member 42 is configured to create turbulence and/or a cyclone effect in the flow of the fluid within the spray body 12 and/or direct the flow of the fluid over the solid chemistry within the cartridge 40 so that the solid chemistry does not dilute too quickly and achieves chemical concentrations needed for effectiveness.

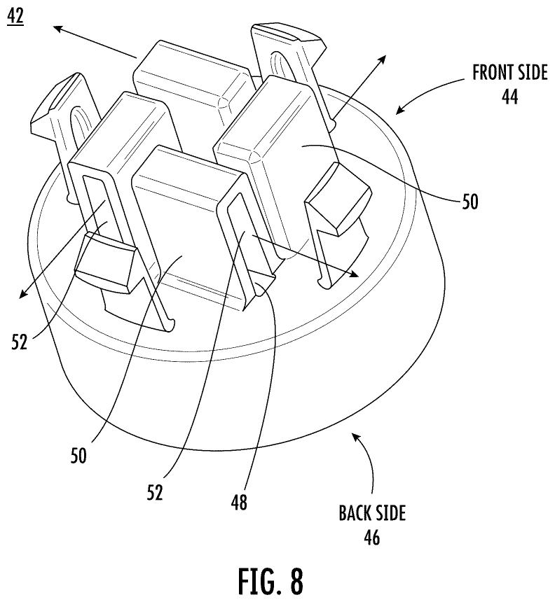

FIG. 8 illustrates an exemplary embodiment of the flow member 42 including a front side 44 and a back side 46, which creates a fluid tumble within the cartridge 40. Without the swirling and tumbling of the fluid, the fluid would directly pass through the cartridge 40 and result in a lower concentration of chemistry. The flow of the fluid enters in a linear fashion on the back side 46 of the flow member 42. The flow member 42 causes a directional change and the flow of the fluid exits in a tangential manner. Configurations of the flow member 42 may include one or more tangential channels 48, preferably two or more tangential channels 48. Channels 48 may be of various geometric shapes such as rectangular or helical. Spacing between the channels 48 may result in greater tangential forces, however, it may or may not result in a greater concentration of the solid chemistry. The flow member 42 has one or more raised projections 50 having fluid exit windows 52, and the fluid exit windows may be rectangular, square, round, or another shape. As illustrated, rectangular is shown. The flow member 42 may have various configurations.

Considerations for selecting a configuration include, but are not limited to, suitability for an injection molding process, and cross-sectional flow area as to not restrict fluid flow. The flow member 42 may have alternate configurations and still be within the scope of the present disclosure so long as the configuration creates a swirl or vortex when the flow of fluid passes through the flow member 42. For example, the flow of fluid enters the flow member 42 as one stream and the configuration of the flow member 42 creates several streams in one direction to produce a swirl or cyclone effect in the flow of the fluid. It is within the scope of the disclosure that there may be alternate configurations of the flow member 42.

Due to the geometry of spray wand 2 and/or the cartridge assembly 14, particularly the flow member 42, the flow of the fluid passes directly over the solid chemistry and out of the spray wand 2. In certain instances, the fluid passes through the cartridge assembly 14 in a tangential swirling manner that tumbles or flows through the solid chemistry, maximizing exposure of the fluid to the solid chemistry, which results in higher applied chemistry concentration of a chemistry fluid mixture.

It is understood that the spray body 12, the cartridge assembly 14, and/or the cartridge 40, may be relatively transparent or semi-transparent to allow monitoring of the cartridge assembly 14, the cartridge 40, and/or a level of the solid chemistry. The spray body 12 and/or the cartridge 40 may also include an indicator/marking (not depicted) to alert the user when the solid chemistry is at a level in which the cartridge 40 should be refilled and/or replaced to achieve a desired concentration level.

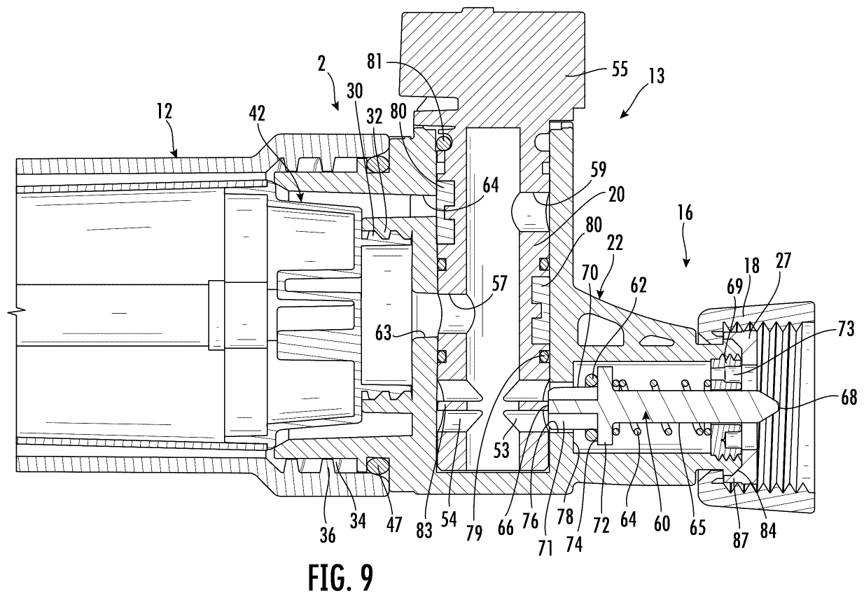

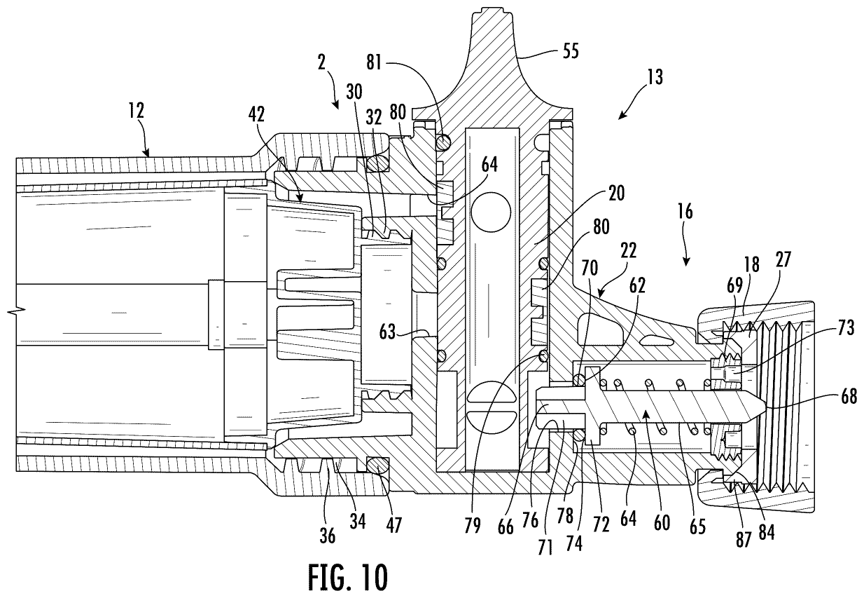

In some embodiments, the cartridge assembly 14 may be releasably coupled to the valve assembly 13. As a non-limiting example, the flow member 42, as shown in FIGS. 9 and 10, may include external threads 30 configured to threadably engage internal threads 32 of the valve assembly 13 of the spray wand 2. Once the cartridge assembly 14 is secure, the valve assembly 13 may be releasably coupled to the spray body 12. For example, the valve assembly 13 may include external threads 34 configured to threadably engage internal threads 36 of the spray body 12. It is understood that the valve assembly 13 may be releasably coupled to the spray body 12 and/or the cartridge assembly 14 by various other methods as desired. A sealing element 47 may be disposed between the valve assembly 13 and the spray body 12 to form a substantial fluid-tight seal therebetween and militate against leakage of the fluid from the spray wand 2.

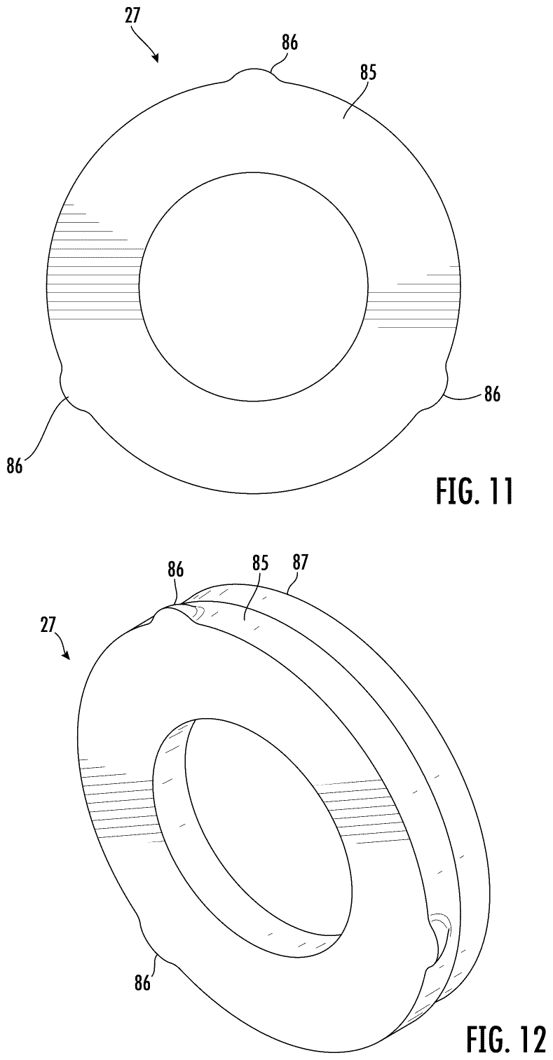

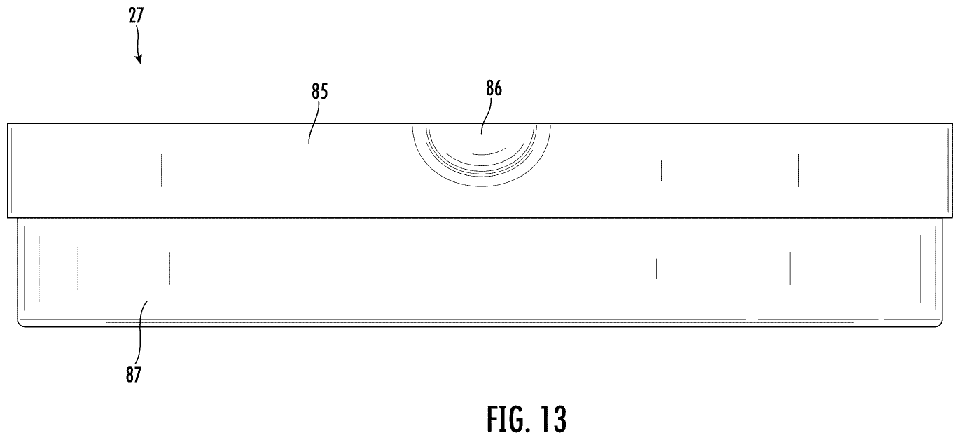

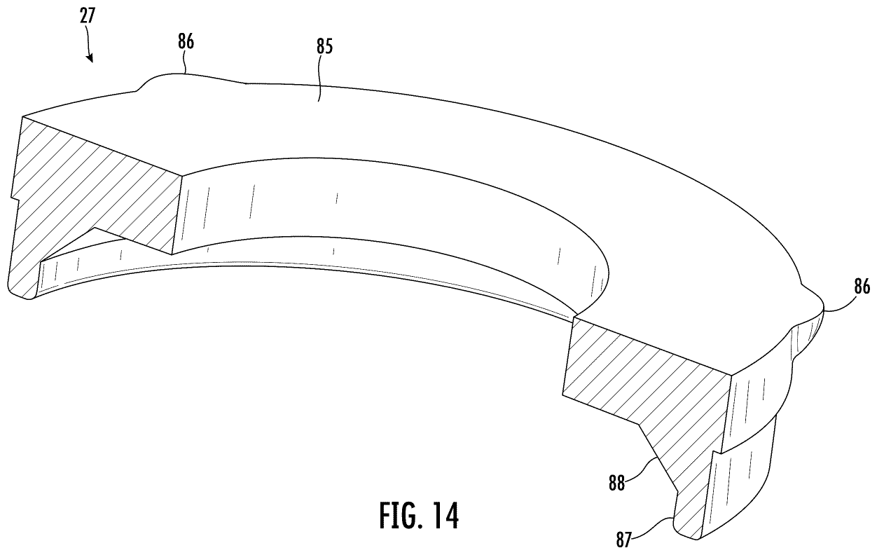

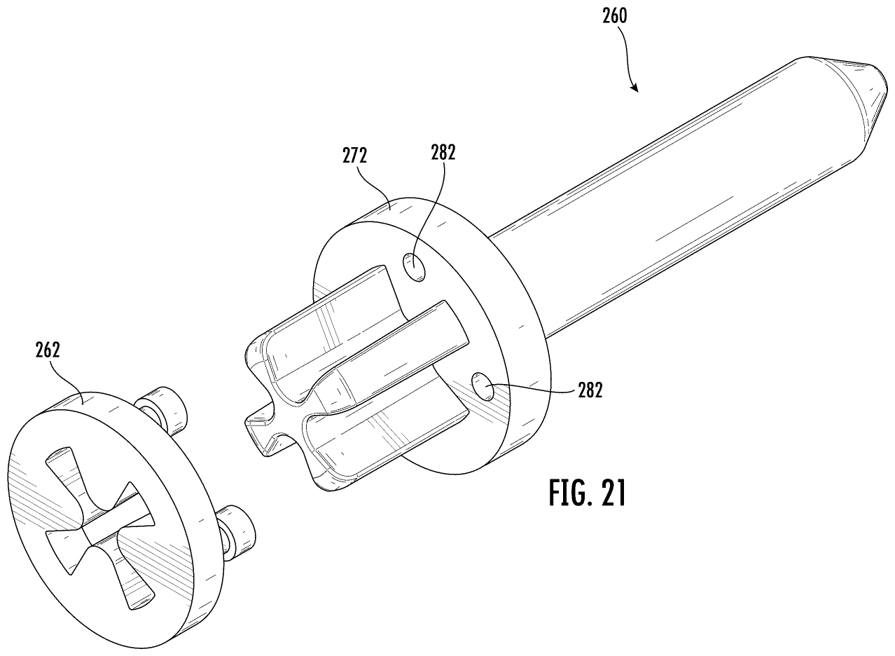

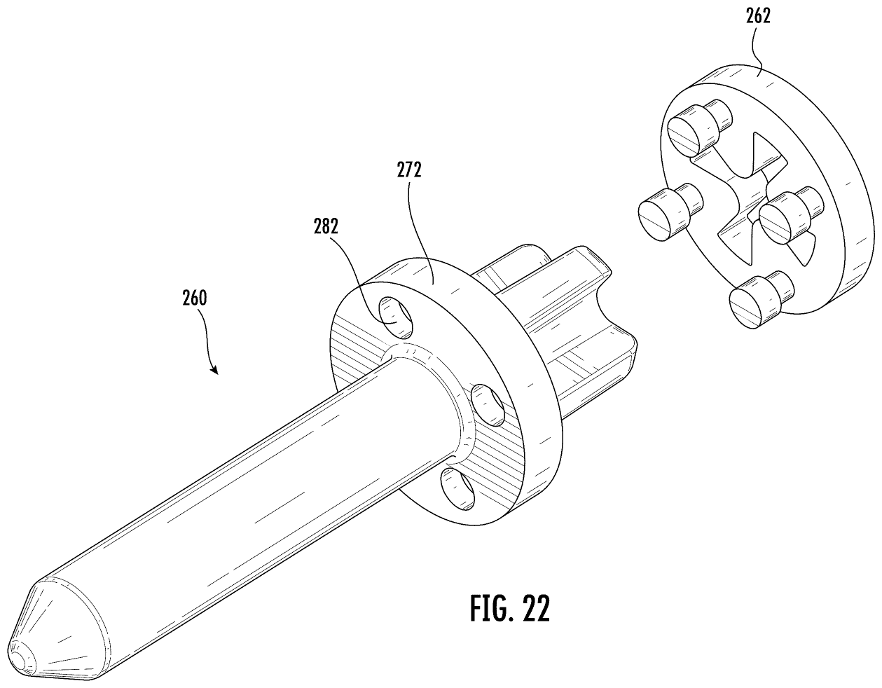

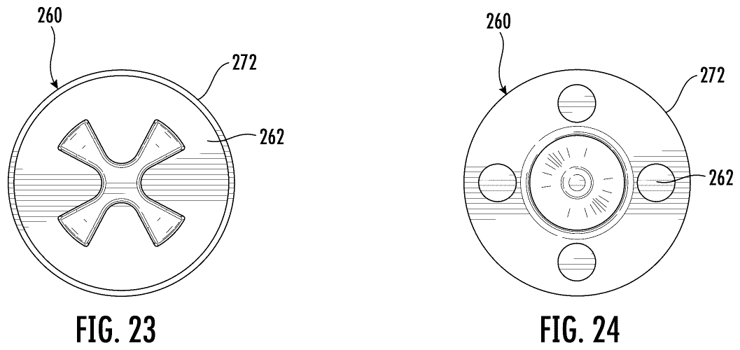

Turning now to FIGS. 9-25, which depict various exemplary embodiments of the spray wand 2, 2′, 2″ and components thereof according to the present disclosure. There are many similarities between the various embodiments, and only the difference between the embodiments will be discussed in detail, it being understood that similar structure for the various embodiments serves similar purposes.

In the embodiment shown in FIGS. 9 and 10, the valve assembly 13 comprises a housing 22 having a flow control valve 20, a piston 60, and a biasing element 64 disposed therein. The valve assembly 13 may be configured to allow the user, for example, to cease or adjust the flow of the fluid from the fluid source during use and/or permit the spray body 12 to be detached from the housing 22 to refill and/or replace the cartridge assembly 14. Although the housing 22 is shown to be releasably coupled to the spray body 12 by threaded engagement, it is understood that the housing 22 and the spray body 12 may be releasably coupled together by various other means and methods as desired.

The valve assembly 13 serves as an input device for the spray wand 12, and has several operative modes according to a user-selected rotational position of the flow control valve 20 relative to the housing 22. The flow control valve 20 is selectively positionable between a closed “OFF” position, as shown in FIG. 9, and an open “ON” position, as shown in FIG. 10. In the “OFF” position, the flow control valve 20 prevents the flow of the source fluid through the spray wand 2. Conversely, in the “ON” position, the flow control valve 20 permits the source fluid to flow through the spray wand 2.

In the embodiment depicted, the flow control valve 20 has a contoured column positioned within a corresponding cylindrical interior space of the housing 22 when assembled and retained by a pin 81 pressed into the housing 22 while permitting rotation of the flow control valve 20. A lever handle 55 may be provided on the contoured column for manual rotation and selection by a user of whether flow is off, directed to the cartridge assembly 14 for mixing, or directed to bypass the cartridge assembly 14. Corresponding indicia may be provided on the housing 22 for reference by the user. The source fluid can enter a distal portion of the contoured column of the flow control valve 20, opposite the lever handle 55, from either of two input channels that are diametrically opposed with respect to a rotational axis thereof, and are referenced nominally herein as a mix input channel 53, with reference to entering the cartridge assembly 14, and a bypass input channel 54, with reference to bypassing the cartridge assembly 14.

When either the mix input channel 53 or the bypass input channel 54 is directed rearward toward and aligned with a single input opening 76 through an interior wall 78 of the housing 22, the source fluid can flow into and along an interior of the contoured column of the flow control valve 20. Thus, either condition corresponds to one of two open positions of the flow control valve 20 and corresponding open conditions of the valve assembly 13.

The source fluid can exit the flow control valve 20 from either of two output channels according to the rotational position of the contoured column relative to the housing 22. The two output channels, referenced as a mix output channel 57 and a bypass output channel 59, are offset along the rotational axis between the lever handle 55 and the distal portion, and are directed in opposite radial directions so as to align in alternating order with respective output openings through the wall of the housing 22 corresponding to mix and bypass modes of the spray wand 2 as the flow control valve 20 is rotated. The output openings, referenced as a mix output opening 63 and a bypass output opening 64, are similarly offset along the rotational axis, but are directed in a common radial direction, forward toward the spray body 12 and the cartridge assembly 14. When either one of the mix output channel 57 or the bypass output channel 59 is directed forward toward and aligned with a respective one of the mix output opening 63 or the bypass output opening 64, the source fluid can forward flow along the interior of the flow control valve 20 and forward therefrom.

To provide for improved sealing within the housing 22, stopper pads 80 may be provided on the contoured column. The stopper pads 80 are designed to travel circumferentially around the rotational axis when the flow control valve 20 is rotated. As illustrated, the stopper pads 80 are positioned as diametrically opposed to the mix output channel 57 and the bypass output channel 59 so as to seal against a respective one of the output openings 63, 64 formed through the wall of the housing 22. Thus, when either the mix output channel 57 or the bypass output channel 59 is directed forward to align with the corresponding mix output opening 63 or bypass output opening 64 by user selection, one of the stopper pads 80 diametrically opposes and seals against the unselected one of the output openings 63, 64. The contoured column is in sealing engagement with the housing 22 by one or more sealing elements 79 (e.g., O-rings) to militate against fluid leakage between output channels 57, 59, and from the valve assembly 13.

As depicted, the flow control valve 20 includes a reciprocating piston 60 provided with a sealing element 62 that, when the piston 60 is in a closed “OFF” position (i.e., a sealing position), prevents unwanted forward flow and leaking of the source fluid corresponding to the closed “OFF” position of the flow control valve 20 and an “OFF” condition of the valve assembly 13. Thus, the piston 60 and the sealing element 62 serve to prevent forward flow of the source fluid into the input opening 76 through the wall 78 of the housing 22. Contrarily, when the piston 60 is in an open “ON” position, the forward flow of the source fluid is permitted corresponding to one of the open “ON” positions of the flow control valve 20 and an “ON” condition of the valve assembly 13.

In some embodiments, the piston 60 comprises an elongate main body 65 having a first end 66 and an opposing second end 68. A retaining element 69 may be employed to maintain a position of the piston 60 within the housing 22 and perform as a stop for a biasing element 64.

As shown in FIGS. 9 and 10, the retaining element 69 may include one or more fluid passageways 73 to allow the flow of the source fluid therethrough. The retaining element 69 may be coupled to the housing 22 by a threaded connection. It is understood, however, that the retaining element 69 may be coupled to the housing 22 by various other methods as desired. The first end 66 of the piston 60 may include outwardly extending projections 70 (e.g., ribs), which form one or more flow channels 71 in the main body 65. In certain embodiments, each of the flow channels 71 extend along an entire length of the projections 70. It is understood, however, that the flow channels 71 may have any size, shape, and configuration as desired. It is also understood that the projections 70 may be integrally formed with the main body 65 if desired. As a non-limiting example, the projections 70 may be configured such that the first end 66 of the piston 60 has a generally X-shaped cross-section. Various other configurations of the projections 70 may be employed. For example, the piston 60 may have more projections 70 than shown and be configured such that the first end 66 of the piston 60 has a generally star-shaped cross-section. As illustrated, the second end 68 may be tapered having a generally circular cross-sectional shape. It is understood, however, that the first and second ends 66, 68 may have any shape, size, and configuration as desired. An annular flange 72 may be provided on the main body 65 intermediate the first and second ends 66, 68. An axial face 74 of the flange 72 may perform as a seating surface for the sealing element 62. The flange 72 may also perform as a stop for the biasing element 64 opposite the retaining element 69, thereby trapping the biasing element 64 therebetween.

When in the closed “OFF” position of the flow control valve 20, the piston 60 is also in the closed “OFF” position with the sealing element 62 forming a fluid-tight seal between the inner surface of the housing 22 and the piston 60 to close the input opening 76 formed in the interior wall 78 of the housing 22 and militate against the flow of the source fluid through the flow channels 71 of the piston 20, and thereby the spray wand 2. The biasing element 64 is compressed upon assembly of the spray wand 2, persistently biasing the piston 60 toward the forward sealing position to sealing element 62 toward the input opening 76 and inner surface of the wall 78.

When in the open “ON” position of the flow control valve 20, the piston 60 is also in the open “ON” position with the sealing element 62 spaced apart from the inner surface of the wall 78 of the housing 22 to permit the flow of the source fluid through the flow channels 71 of the piston 60 and the inlet opening 76 of the housing 22. Accordingly, the flow of the fluid is permitted through the spray wand 2. As described hereinabove, a biasing force of the biasing element 64 urges the piston 60 into the closed “OFF” position. Accordingly, the flow control valve 20 is configured to apply an opposing force on the piston 60 greater than the biasing force of the biasing element 64 to cause the piston 60 to move to the open “ON” position when the open “ON” position of the flow control valve 20 is desired. In particular embodiments, the force of the flow control valve 20 on the piston 60 overcomes the biasing force of the biasing element 64, compressing the biasing element 64 against the retaining element 69. Preferably, the biasing element 64 has a compression rate in a range of about 2.5 lbs./inch to about 6.5 lbs./inch, and more preferably about 4.7 lbs./inch. It is understood that various types of biasing elements (e.g., a helical spring) may be employed as the biasing element 64 if desired.

In certain embodiments, upon rotation of the flow control valve 20 from either closed “OFF” position, the piston 60 is pressed rearward from the sealing position. When either of the mix input channel 53 and the bypass input channel 54 is directed toward the input opening 76, corresponding to the mix and bypass conditions, the biased piston 60 is urged and maintained rearward from the sealing position, thus opening the valve assembly 13 for source fluid entry. A respective cam 83 is positioned in an opening of each of the mix input channel 53 and the bypass input channel 54 of the flow control valve 20, urging and maintaining the piston 60 rearward from the sealing position against the biasing force of the biasing element 64. A forward face of the first end 66 of the piston 60 may be substantially planar to smoothly engage either cam as the flow control valve 20 is rotated. Each cam 83 bifurcates its respective input channel 53, 54.

As source fluid flows from the fluid source, the fluid enters the valve assembly 13 m flows through the fluid passageways 73 of the retaining element 69, around and past the unseated piston 60, along the flow channels 71, and into the aligned mix input channel 53 or bypass input channel 54. The source fluid entering the flow control valve 20 in either open “ON” position of the flow control valve 20, with reference to either the mix input channel 53 or the bypass input channel 54 being directed rearward, travels along the interior of the contoured column and exits the flow control valve 20 through either the forward directed mix output channel 57 or bypass output channel 59 respectively. From there, the fluid flow through either the mix output opening 63 or bypass output opening 64, thus exiting the valve assembly 13 and entering the spray body 12.

In particular embodiments, the housing 22 may be provided with a hose nut 18 located at the source end 16 of the spray wand 2. The fluid source may be releasably coupled and fluidly connected to the hose nut 18. In a non-limiting example, an end of the hose may be received and releasably coupled to the hose nut 18. A sealing element 27 may be disposed inside of the hose nut 18 to form a substantially fluid-tight seal between the hose, the housing 22, and the hose nut 18 and militate against fluid leakage therebetween. The sealing element 27 may be configured to prevent inadvertent and undesirable mispositioning and/or deformation thereof within the hose nut 18, which can lead to leakage of the fluid from the spray wand 2.

In the exemplary embodiment of the sealing element 27 shown in FIGS. 11-14, the sealing element 27 comprises a main body 85 having one or more surface features 86 for engagement with the hose nut 18. The surface features 86 may be configured to seat between internal threads of the hose nut 18 to maintain a position of the sealing element 27 within the hose nut 18. Although it is understood that other surface features and/or means of engagement may be employed to maintain the position of the sealing element 27. As illustrated, the main body 85 of the sealing element 27 may further include an annular hub portion 87 having a generally planar contact region 88. The contact region 88 is configured to mate with a chamfered end 84 of the housing 22, as depicted in FIGS. 9 and 10, thereby increasing the contact area between the sealing element 27 and the housing 22. This enhanced interface forms a substantially fluid-tight seal therebetween and reduces the risk of fluid leakage from the spray wand 2.

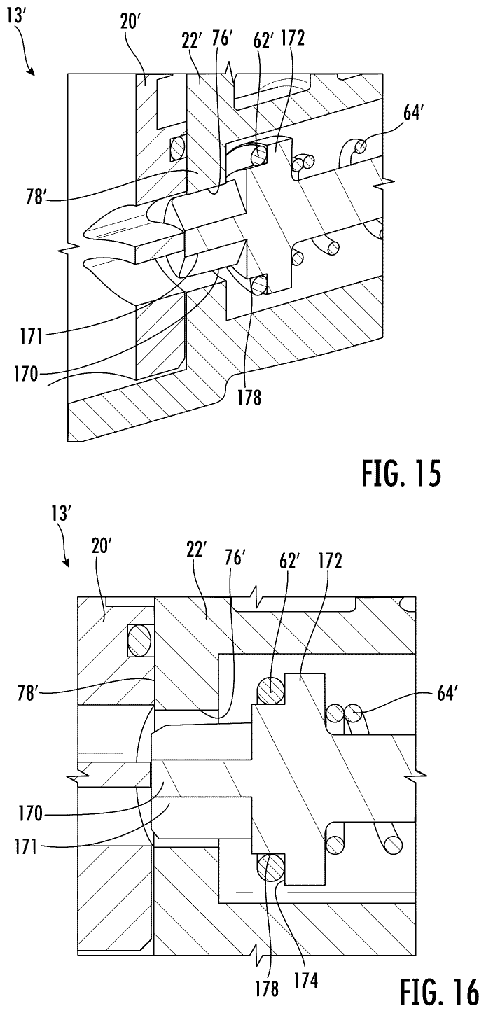

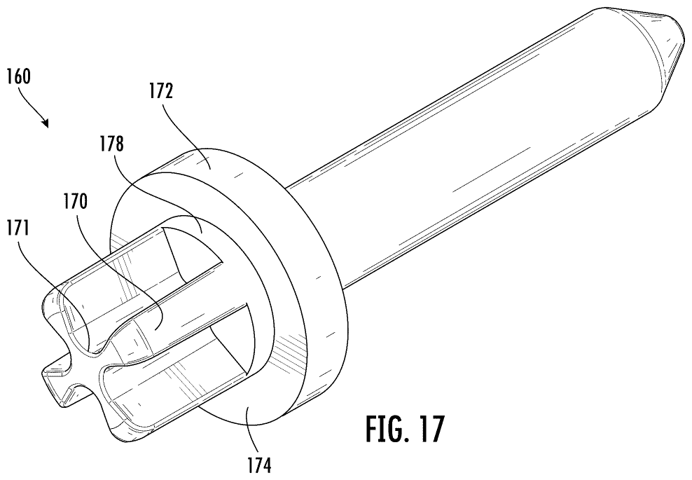

FIGS. 15-16 depict another exemplary embodiment of a valve assembly 13′ for a spray wand 2′ having an alternate design of a piston 160, more clearly shown in FIG. 17. Similar structure of the spray wand 2′ as to that of the spray wand 2 described herein and depicted in FIGS. 1-14 is identified with the same reference numeral and includes a prime symbol (′). For simplicity, the following description will refer only to the non-prime reference numerals. As best seen in FIG. 17, the piston 160 may include an annular hub 178 formed adjacent a flange 172.

An outer periphery of the hub 178, as shown in FIGS. 15 and 16, may perform an another seating surface for the sealing element 62′ to improve the fluid-tight seal between the inner surface of the housing 22′ and the piston 160 to close the inlet opening 76′ and militate against the flow of the source fluid through flow channels 171 formed by projections 170 of the piston 160, and thereby the valve assembly 13′.

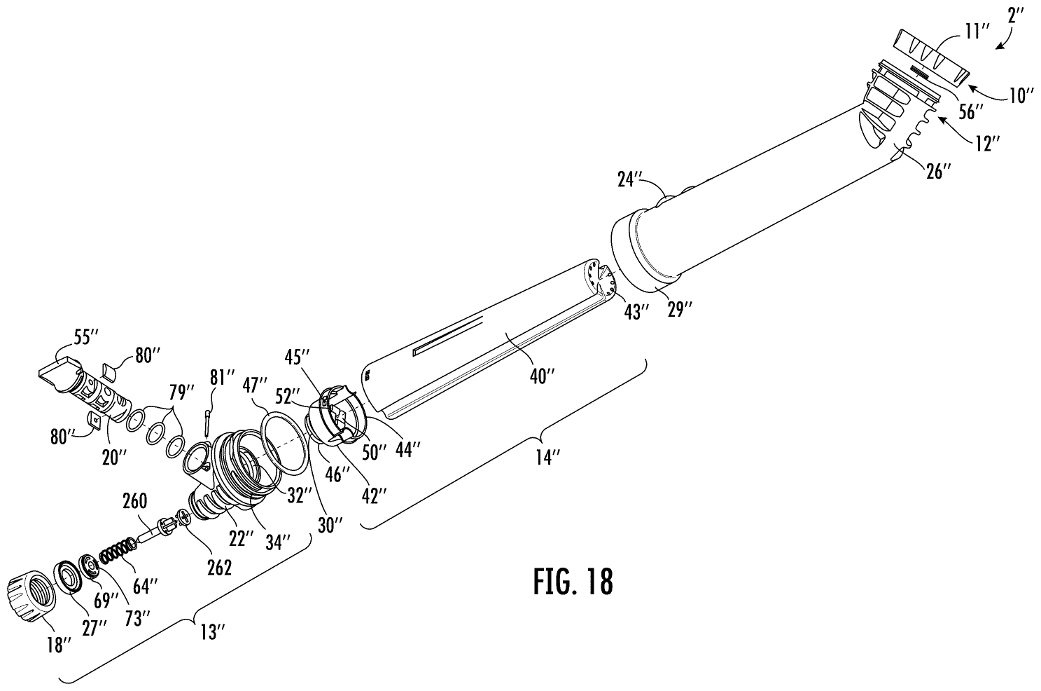

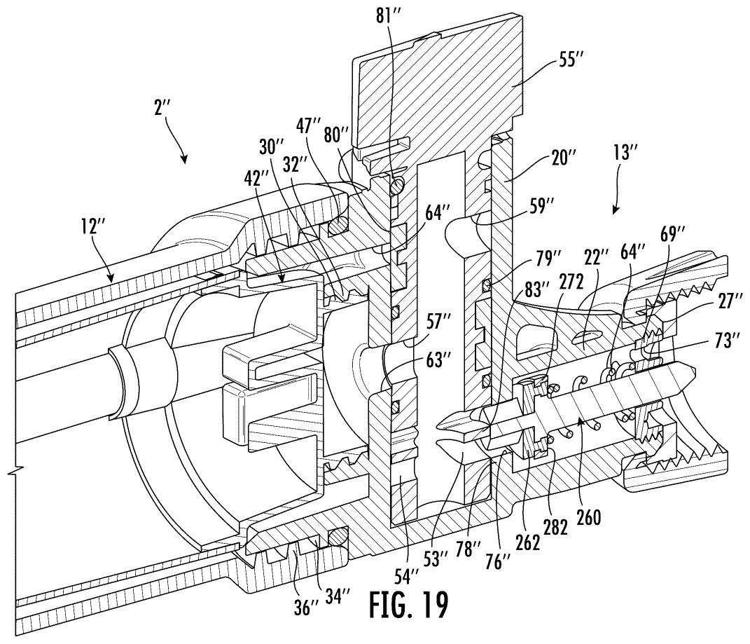

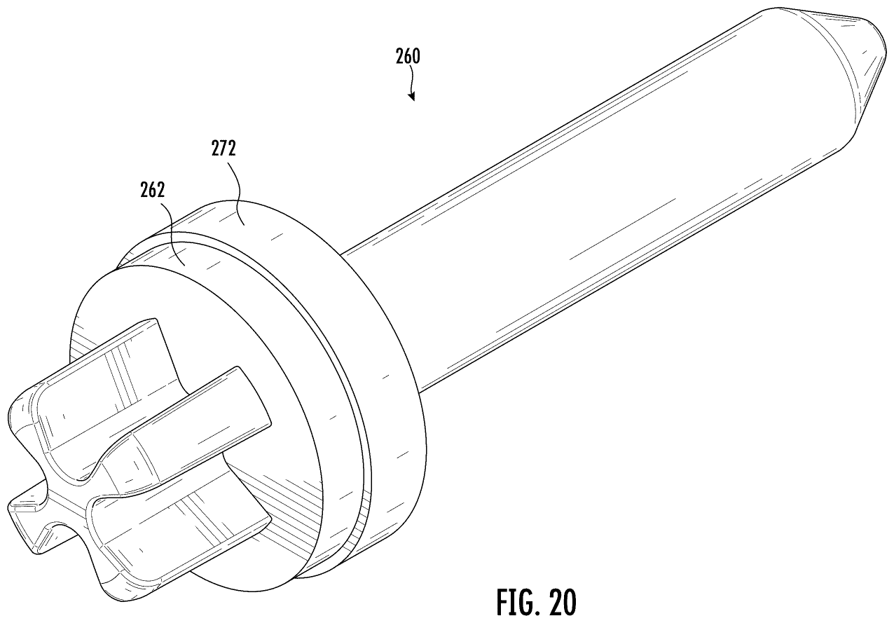

In yet another exemplary embodiment of a spray wand 2″ shown in FIGS. 18 and 19, the valve assembly 13″ includes another alternate design of a piston 260 and a sealing element 262, as more clearly shown in FIGS. 20-24. Similar structure of the spray wand 2″ as to that of the spray wands 2, 2′ described herein and depicted in FIGS. 1-17 is identified with the same reference numeral and includes a double prime symbol (″). For simplicity, the following description will refer only to the non-prime reference numerals. In particular, the valve assembly 13″ includes an over-molded seal as the sealing element 262 on the piston 260, instead of the free sealing elements 62, 62′ (e.g., an O-ring). The over-molded sealing element 262 is advantageous over the use of the free sealing elements 62, 62′ by minimizing deformation thereof that adversely affects the flow of the fluid when in the open “ON” position of the flow control valves 20, 20′ and “ON” condition of the valve assemblies 13, 13′ and leads to fluid leakages of the source fluid when in the closed “OFF” position of the flow control valves 20, 20′ and “OFF” condition of the valve assemblies 13, 13′. Moreover, the over-molded sealing element 262 remains together with the piston 260 without becoming separated even when exposed to a flow of a relatively high-pressure fluid. Additionally, the over-molded sealing element 262 reduces error in assembly of the valve assembly 13″. Thus, the over-molded sealing element 262 provides further improvement of the valve assembly 13″ over the prior art as well as other embodiments of the present disclosure.

In certain instances, a flange 272 of the piston 260 includes one or more openings 282, each having a mechanical undercut as shown in FIG. 19 to maintain a position of the sealing element 262 on the piston 260 and militate against undesired removal of the sealing element 262 therefrom. Preferably, the sealing element 262 may be produced from an ethylene propylene diene monomer (EPDM) material since the EPDM material exhibits a minimal compression set under the biasing force of the biasing element 64″ when in the “OFF” position of the flow control valve 20″ and “OFF” condition of the valve assembly 13″. Per American Society for Testing and Materials (ASTM) D2000 (125*C, 22 hr), EPDM has a compression set of about 25% versus that of a thermoplastic vulcanizate of about 40% and a thermoplastic elastomer (styrenic block copolymer) of about 92%. It should be appreciated, however, that the sealing element 262 may be formed from various other materials if desired such as a nitrile butadiene rubber (i.e., Buna-N), a fluoroelastomer (e.g., Viton™ a brand of The Chemours Company), and the like, for example. The sealing element 262 is sized to allow a certain amount of the flow of the fluid around the piston 260. In a non-limiting example, the sealing element 262 may have a diameter of about 12 mm and a thickness of about 2 mm. It should be appreciated that the sealing element 262 may be produced from any resiliently deformable material and have any shape, size, and configuration as desired to achieve a desired sealing and flow of fluid around the piston 260.

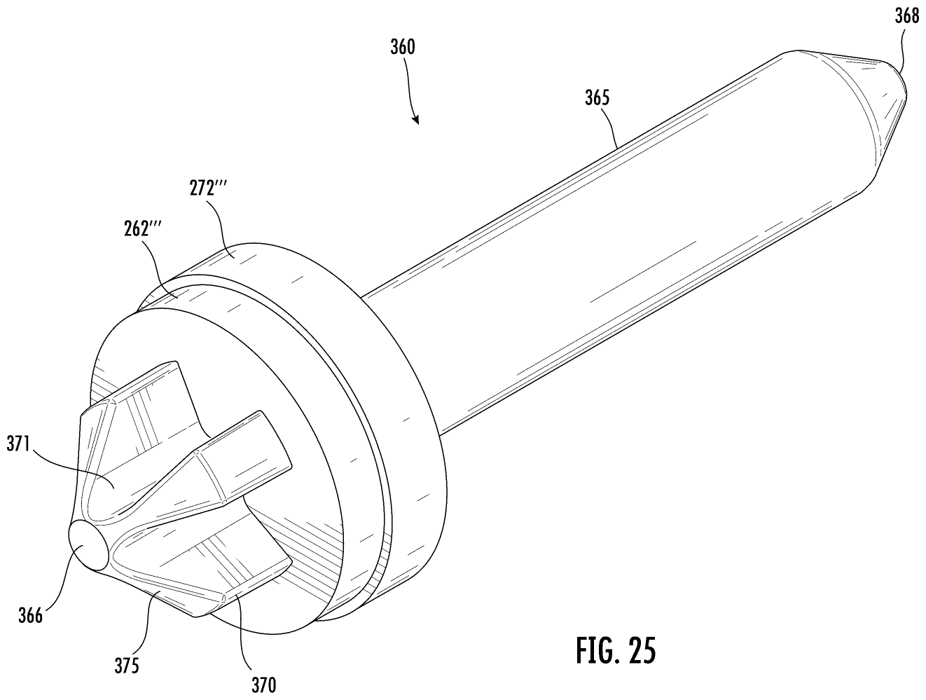

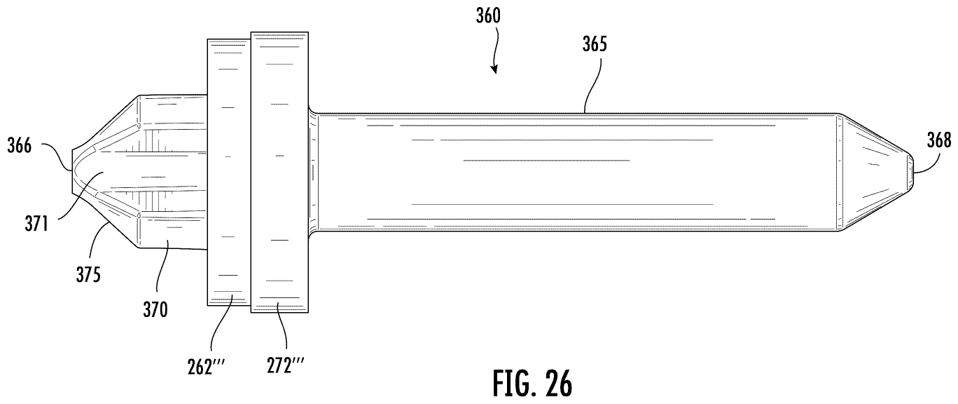

FIGS. 25 and 26 illustrate yet another alternate design of a piston 360. Similar structure of the piston 360 as to that of the piston 260 described herein and depicted in FIGS. 20-24 is identified with the same reference numeral and includes a triple prime symbol (″′). For simplicity, the following description will refer to the non-prime reference numerals. In particular, the piston 360 comprises an elongate main body 365 having a first end 366 and an opposing second end 368. The first end 366 of the piston 360 may include outwardly extending projections 370 (e.g., ribs). Each of the projections 370 may include a chamfer 375 to provide improved haptic feedback to the user upon activation of a flow control valve. In certain embodiments, an angle of the chamfer 375 may be about 45 degrees relative to a central axis of the piston 360. It is understood that the chamfer 375 may be formed at any suitable angle as desired. As depicted, the projections 370 form one or more flow channels 371 in the main body 365. Each of the flow channels 371 extend along an entire length of the projections 370. The projections 370 may be configured such that the first end 366 of the piston 360 has a generally X-shaped cross-section. It is understood, however, that the piston 360 may have more projections 370 than shown and be configured such that the first end 366 of the piston 360 has a generally star-shaped cross-section. As illustrated, the second end 368 may be tapered having a generally circular cross-sectional shape. It is understood, however, that the first and second ends 366, 368 may have any shape, size, and configuration as desired. An annular flange 272″′ may be provided on the main body 365 intermediate the first and second ends 366, 368. An axial face 274″′ of the flange 272″′ may perform as a seating surface for the sealing element 262″′.

There are numerous benefits associated with the spray wands 2, 2′, 2″ and associated components thereof of the present disclosure. The benefits of the spray wands 2, 2′, 2″ include, but are not limited to, ergonomic, ease of refill, longer lasting chemistry, farther spray distance and with longer reach, easy visibility for refill/transparent, versatility in range of motion, and metering benefits, improved safety, solid chemistry lighter weight for shipping and usage, among others.

The spray wands 2, 2′, 2″ of the present disclosure are ergonomic, for example, by providing balance to the user as the hose is connected into the handle such that a consumer can use the spray wands 2, 2′, 2″ with one hand while cleaning as opposed to requiring use of two hands. The use of solid chemistry in the spray wands 2, 2′, 2″ of the present disclosure makes the spray wands 2, 2′, 2″ lighter in weight as compared to other products requiring water as part of their formulation chemistry.

From the foregoing description, one ordinarily skilled in the art can easily ascertain the essential characteristics of this disclosure and, without departing from the spirit and scope thereof, can make various changes and modifications to the disclosure to adapt it to various usages and conditions.

What is claimed is:

1. A spray wand, comprising:
a spray body provided with a nozzle;
a valve assembly coupled to the spray body; and
a cartridge assembly disposed in the spray body, the cartridge assembly comprising a cartridge including:
a tubular member having a proximal end and a distal end; and
a plurality of apertures formed in the distal end of the tubular member, wherein the apertures are arranged in opposing radial arrays.

2. The spray wand of claim 1, wherein at least one of the apertures has a diameter in a range of about 0.050 inches to about 0.150 inches.

3. The spray wand of claim 1, wherein the cartridge includes eight apertures.

4. A spray wand, comprising:
a spray body provided with a nozzle;
a cartridge assembly disposed in the spray body; and
a valve assembly coupled to the spray body, the valve assembly comprising:
a housing having a chamfered end and provided with a hose nut;
a first sealing element disposed within the hose nut, wherein the first sealing element is configured to sealingly engage the chamfered end of the housing;
a flow control valve disposed in the housing; and
a piston disposed in the housing, the piston provided with a second sealing element, wherein the piston is selectively positionable between a first position to militate against a flow of a fluid through the valve assembly and a second position to permit the flow of the fluid through the valve assembly.

5. The spray wand of claim 4, wherein the first sealing element comprises a main body having an annular hub portion.

6. The spray wand of claim 5, wherein the annular hub portion includes a generally planar contact region configured to interface with the chamfered end of the housing to form a generally fluid-tight seal therebetween.

7. The spray wand of claim 4, wherein the piston includes one or more projections, forming fluid channels formed in an end thereof.

8. The spray wand of claim 4, wherein the piston includes an annular flange having a seating surface for the sealing element.

9. The spray wand of claim 4, wherein the piston includes an annular hub having a seating surface for the second sealing element.

10. The spray wand of claim 4, wherein the second sealing element is an O-ring.

11. The spray wand of claim 4, wherein the second sealing element is an over-molded sealing element.

12. The spray wand of claim 4, wherein the second sealing element is produced from at least one of an ethylene propylene diene monomer (EPDM) material, a nitrile butadiene rubber material, and/or a fluoroelastomer material.

13. The spray wand of claim 4, wherein the second sealing element has a compression set of about 25%.

14. The spray wand of claim 4, further comprising a biasing element to apply a biasing force on the piston, wherein the biasing force is in a range of about 2.5 lbs./inch to about 6.5 lbs./inch.

15. The spray wand of claim 14, wherein the biasing element urges the piston into the first position.

16. A spray wand, comprising:
a spray body provided with a nozzle, the nozzle comprising;
a movable member; and
an orifice formed in the movable member, the orifice having an inlet opening and an outlet opening, wherein the orifice includes an inner surface that slopes inward towards a centerline of the orifice;
a valve assembly coupled to the spray body; and
a cartridge assembly disposed in the spray body.

17. The spray wand of claim 16, wherein an inner diameter of the orifice gradually decreases from the inlet opening of the orifice to the outlet opening thereof.

18. The spray wand of claim 16, wherein an inner diameter of the orifice at the inlet opening is about 0.170 inches and an inner diameter of the orifice at the outlet opening is about 0.110 inches.

19. The spray wand of claim 16, wherein a slope angle of the inner surface of the orifice relative to the centerline is in a range of about 0 degrees to about 45 degrees.

20. The spray wand of claim 16, wherein a slope angle of the inner surface of the orifice relative to the centerline is about 6.5 degrees.
